(19) United States
(12) Patent Application Publication
(10) Pub. No.: US 2017/0019863 A1
(43) Pub. Date: Jan. 19, 2017

(54) UPLINK POWER CONTROL FOR USER DEVICES AT VARYING DISTANCES FROM AN ACCESS POINT

(71) Applicant: Intel IP Corporation, Santa Clara, CA (US)

(72) Inventors: Laurent Cariou, Portland, OR (US); Robert Stacey, Portland, OR (US)

(21) Appl. No.: 14/757,861

(22) Filed: Dec. 26, 2015

Related U.S. Application Data
(60) Provisional application No. 62/192,328, filed on Jul. 14, 2015.

(51) Int. Cl. H04W 52/28; H04W 76/02; H04W 72/08; H04W 72/04

(52) U.S. Cl. CPC H04W 52/283; H04W 72/0413; H04W 76/02; H04W 72/085

(57) ABSTRACT

This disclosure describes methods, wireless stations, and systems related to a flexible connectivity framework that controls transmitting power levels of wireless stations to a common access point based on information provided by the access point. For example, a method may be provided, wherein the method includes performing the operations of: determining a transmitting power level of a wireless access point; determining a target receiving power level of the wireless access point; transmitting an indication of the transmitting power level and the target receiving power level of the access point to one or more wireless stations; and receiving one or more data transmissions from the one or more wireless stations.

### CROSS REFERENCE TO RELATED APPLICATION

This application claims the benefit of U.S. Patent Application No. 62/192,328 filed on Jul. 14, 2015, the disclosure of which is incorporated herein by reference as set forth in full.

### TECHNICAL FIELD

This disclosure generally relates to systems and methods for wireless communications and, more particularly, to uplink power control for users sending and receiving data transmissions at varying distances.

### BACKGROUND

Wireless devices are becoming widely prevalent and are increasingly requesting access to wireless channels. A next generation Wireless Local Area Network (WLAN), IEEE 802.11 ax or High-Efficiency WLAN (HEW) standard, is under development. HEW utilizes Orthogonal Frequency-Division Multiple Access (OFDMA) in channel allocation and is aimed to enhance Wi-Fi performance in indoor and outdoor scenarios. New HEW features are introduced to improve the spectral efficiency and user-throughputs of Wi-Fi in dense deployments. These will involve changes to the physical (PHY) and medium access control (MAC) layers.

### BRIEF DESCRIPTION OF THE DRAWINGS

FIG. 1 depicts an example network environment of an illustrative OFDMA uplink resource allocation architecture, according to one or more example embodiments of the disclosure.

FIG. 2 is a schematic diagram depicting an example resource allocation in an OFDMA uplink resource allocation system, according to one or more example embodiments of the disclosure.

FIG. 3 is a schematic diagram depicting an example resource block allocation, according to one or more example embodiments of the disclosure.

FIG. 4 depicts an illustrative transmission and reception of resource requests, according to one or more example embodiments of the disclosure.

FIG. 5 is a system diagram depicting an exemplary near-far problem between an access point and two wireless stations (e.g., user devices), according to one or more example embodiments of the disclosure.

FIG. 6 depicts an illustrative transmission between an access point and two wireless stations, according to one or more example embodiments of the disclosure.

FIG. 7 is a process flow diagram of an illustrative method for implementing power control procedures described herein, according to one or more example embodiments of the disclosure.

FIG. 8 is a process flow diagram of another illustrative method for implementing power control procedures described herein, according to one or more example embodiments of the disclosure.

FIG. 9 depicts a block diagram of an example computing device, according to one or more example embodiments of the disclosure.

FIG. 10 depicts an example radio unit, according to one or more example embodiments of the disclosure.

FIG. 11 depicts an example computational environment, according to one or more example embodiments of the disclosure.

FIG. 12 depicts another example computing device, according to one or more example embodiments of the disclosure.

The detailed description is set forth with reference to the accompanying drawings, which are not necessarily drawn to scale. The use of the same reference numbers in different figures indicates similar or identical items. Illustrative embodiments will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

### DETAILED DESCRIPTION

Example embodiments described herein provide certain systems, methods, and devices for providing a framework for flexible connectivity between wireless devices.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A design target for HEW is to adopt methods to improve the efficiency of Wi-Fi, particularly in dense deployments of Wi-Fi devices, such as in malls, conference halls, etc. HEW may use OFDMA techniques for channel access in the uplink and downlink directions. It is understood that the uplink direction is from a user device to an access point (AP), and the downlink direction is from an AP to one or more user devices. In the uplink direction, one or more user devices may be communicating with the AP and may be competing for channel access in a random channel access manner. In that case, the channel access in OFDMA may require coordination among the various user devices that may be competing to access the operating channel simultaneously. A trigger frame may consist of a preamble along with other signaling, such as resource allocation, to coordinate the uplink OFDMA operation. A trigger frame may be a frame comprising a preamble and other fields (e.g., a frame control field, frame duration field, destination address field, source address field, basic service set identification field, sequence control field, frame body field, and frame check sequence). A trigger frame may be sent from an AP to one or more user devices serviced by the AP informing the user device(s) that channel access is available.

According to one or more OFDMA techniques, an AP may transmit a trigger frame allocating resources. Individual stations use the allocated resource (e.g., 2 MHz of spectrum in a particular portion of the channel) to transmit their data back to the AP. Therefore, with this approach, the station may only transmit a narrow bandwidth signal in response to a trigger frame. However, the AP does not know which stations or how many have data to send.

Example embodiments of the present disclosure relate to systems, methods, and devices for an OFDMA uplink resource allocation framework that may enable two-phase uplink (UL) multi-user (MU) transmissions, a resource request phase, and a data transmission phase. The first phase (resource request phase) may be triggered by the AP, where the AP may ask the stations (STAs) to send a specific signal with UL OFDMA if they want to have a transmit opportunity in the second phase or in future UL MU transmissions. The characteristics of the signal sent by an STA may enable the AP to identify the STA as an associated STA or an unassociated STA. An STA that uses a frequency resource unit and a code sequence from a P-matrix, assigned to it by an AP, and to communicate with the AP, may be an assigned STA. The frequency resource unit may correspond to one of a plurality of frequencies that the STA and the AP may use to communicate with one another. The code sequence from the P-matrix may correspond to a plurality of bits that may be used by the AP or STA to generate an analog signal. Each of the code sequences in the P-matrix may be orthogonal to each of the other code sequences in the P-matrix. Therefore each analog signal corresponding to each code sequence may be orthogonal to each of the other analog signals corresponding to each of the other code sequences in the P-matrix. The frequency resource unit and code sequence may correspond to a resource block (RB) tuple that may be assigned an alphanumeric identification (ID). The tuple may be referred to as an RBID. Each assigned STA may have at least one RBID assigned to it.

An STA that does not have an RBID assigned to it may be an unassigned STA. For example, if an AP detects energy on an RB corresponding to an unassigned RBID, the AP may identify the STA as an unassociated STA. The OFDMA uplink resource allocation device may be configured to define the signal as a code sequence (line of the P-matrix) of the HE-LTF, sent on only a resource unit in frequency (26 tone allocation) using UL OFDMA. A combination of the code sequence and frequency resource unit may have a corresponding RBID associated with it.

An AP may determine the identity of a user device by detecting energy on a resource block corresponding to an RBID. There may be a one-to-one relationship between an STA address and the RBID thereby allowing the AP to identify an STA. The AP can acknowledge to the STAs that it received the resource requests. The second phase is a regular scheduled UL MU transmission, which starts with a trigger frame sent by the AP, announcing the identity of the STAs that will transmit in the UL MU transmission, and other information like the allocated resources.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device,” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, a user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one-way and/or two-way radio communication systems, cellular radio-telephone communication systems, a mobile phone, a cellular telephone, a wireless telephone, a personal communication systems (PCS) device, a PDA device which incorporates a wireless communication device, a mobile or portable global positioning system (GPS) device, a device which incorporates a GPS receiver or transceiver or chip, a device which incorporates a radio frequency identification (RFID) element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MCM), discrete multi-tone (DMT), Bluetooth, global positioning system (GPS), Wi-Fi, Wi-Max, ZigBee™, ultra-wideband (UWB), global system for mobile communication (GSM), 2G, 2.5G, 3G, 3.5G, 4G, fifth generation (5G) mobile networks, 3GPP, long term evolution (LTE), LTE advanced, enhanced data rates for GSM evolution (EDGE), or the like. Other embodiments may be used in various other devices, systems, and/or networks.

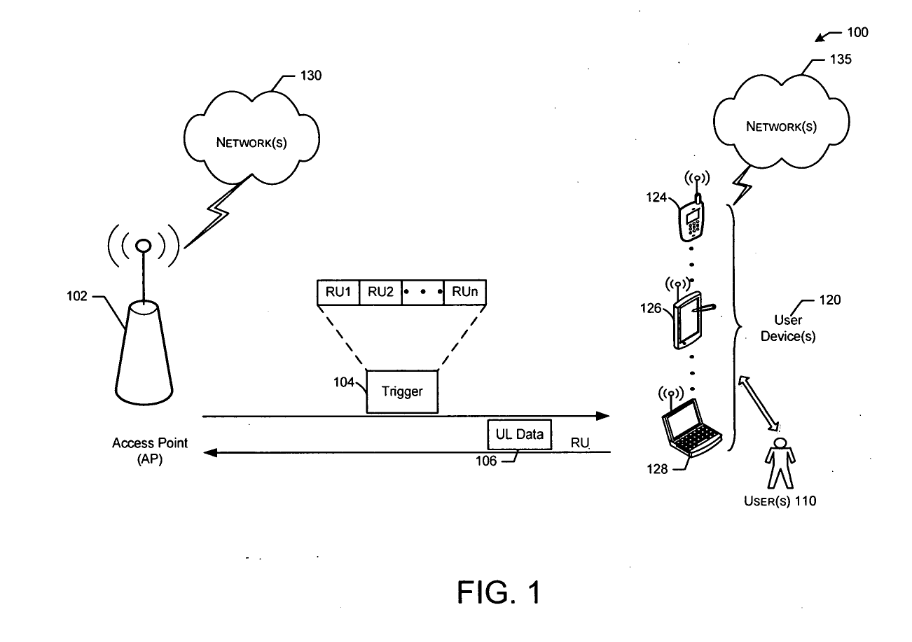

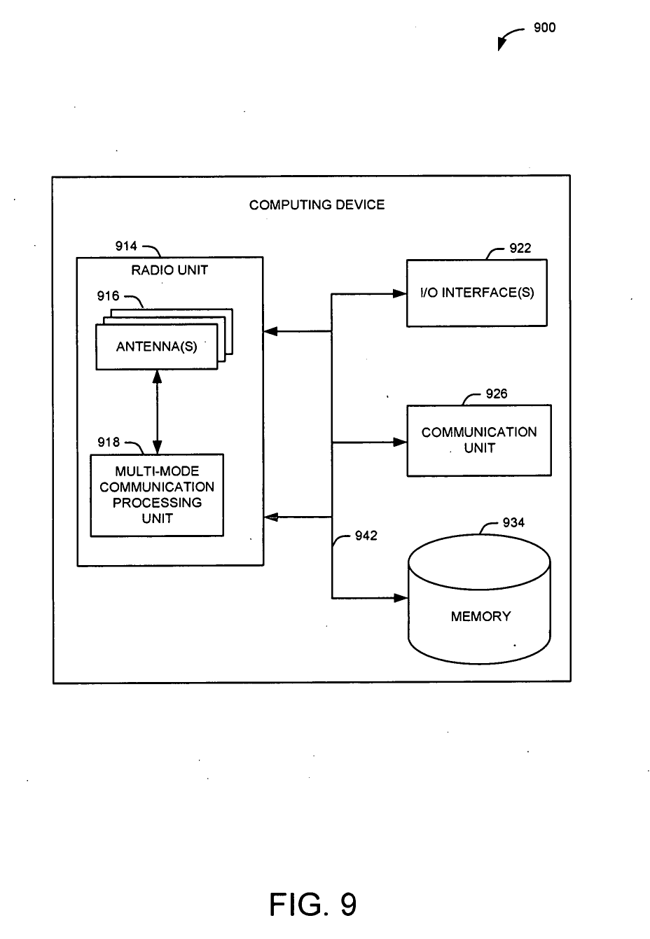

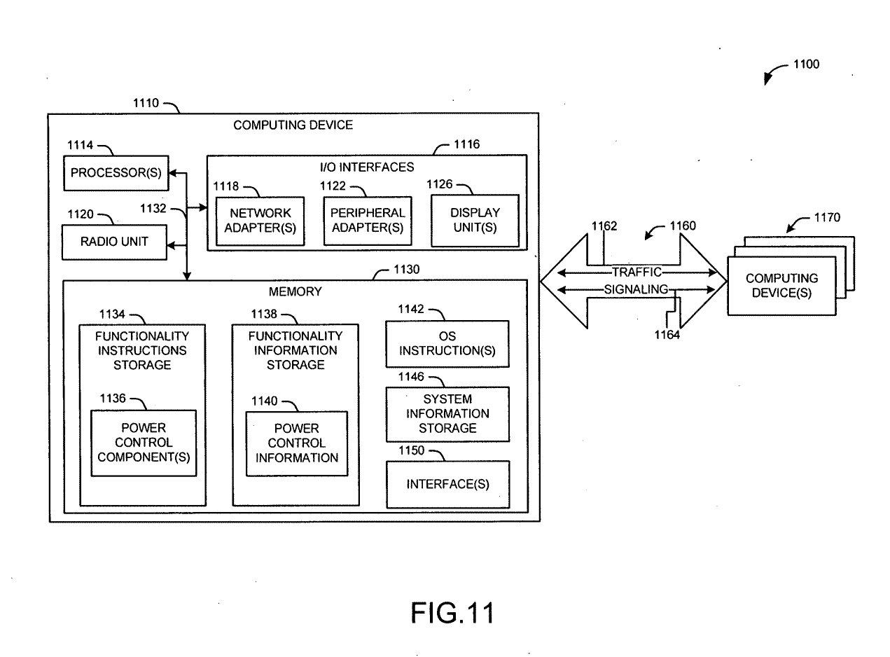

The illustrative wireless network 100 of FIG. 1 may include one or more AP(s) 102 that communicate with one or more user device(s) 120, in accordance with IEEE 802.11 communication standards, including IEEE 802.11ax. The one or more user device(s) 120 and the one or more APs 102 may be devices that are non-stationary without fixed locations or may be stationary with fixed locations. In some embodiments, the user device(s) 120 and AP 102 can include one or more computer systems having a configuration similar to that depicted in FIG. 9 and/or a configuration similar to the example machine/system, depicted in FIGS. 11 and/or 12. One or more illustrative user device(s) 120 may be operable by one or more user(s) 110. The user device(s) 120 (e.g., 124, 126, or 128) may include any suitable processor-driven user device including, but not limited to, a desktop user device, a laptop user device, a server, a router, a switch, an access point, a smartphone, a tablet, a wearable wireless device (e.g., a bracelet, a watch, glasses, a ring, etc.) and so forth. Any of the user devices 120 (e.g., 124, 126, or 128) may be configured to communicate with each other and any other component of the wireless network 100 via one or more communications networks 130, 135 wirelessly or wired.

Referring to FIG. 1, there is shown a network diagram illustrating an example wireless network 100 for an OFDMA uplink resource allocation system, according to some example embodiments of the present disclosure. In this environment, user devices 120, including HEW user devices, may communicate with each other and transmit data on an operating channel. These user devices may randomly access the operating channel to transmit their data. However, there may be situations where the user devices may access the operating channel using assigned (or scheduled) resource units.

In the case of random access, an access point (e.g., AP 102) may send a random access trigger frame (e.g., trigger frame 104) indicating that resource units are available for random access such that the random access resource units may be selected by the user devices (e.g., user devices 124, 126, and/or 128) to send and/or receive data. The resource units may be represented by RU₁, RU₂, . . . , RUₙ, where “n” is an integer greater than or equal to 1. These resource units may be arranged in a sequence such that a user device may determine which resource unit was selected when the user device is ready to transmit its data. These resource units may be resources in time domain, frequency domain, or a combination of time and frequency domain. The user device may use one of these resource units in order to send data to an access point (e.g., AP 102). Consequently, when a user device 120 detects the trigger frame 104, the user device 120 may identify it as a random access trigger frame. This may be achieved by the access point setting an identifier in the trigger frame or by other means to flag the trigger frame as a random access trigger frame. The user device may then select a resource unit from the resource units referenced in trigger frame 104 by which to transmit at least a portion of its data to the AP 102. The selection of the resource unit may be done by employing various embodiments of the present disclosure. In response to trigger frame 104, one or more of User Device(s) 120 may send data to AP 102 using Uplink Data (UL) 106. UL 106 may contain data that User Device(s) 120 may send to each other or data that User Device(s) 120 may send to other computing devices connected to the Internet, that are not depicted in FIG. 1.

In one embodiment, an OFDMA uplink resource allocation system may enable two phases for UL MU transmissions. The first phase is a resource allocation phase triggered by the AP during which the AP requests STAs to send a specific signal if they want to have a transmit opportunity in the second phase or in future UL MU transmissions. The characteristics of the signal sent by the STAs enables the AP to identify the STAs as associated STAs or unassociated STAs. A solution may consist of defining the signal as a code sequence (line of the P-matrix) of the HE-LTF, sent on only a resource unit in frequency (26 tone allocation) using UL OFDMA. The energy detection of the code and frequency unit may enable the AP to know the identity of the STA. The second phase may be a scheduled UL MU transmission, which may include a trigger frame sent by the AP, announcing the identity of the STAs that may transmit in the UL MU transmission, and other information, for example, the allocated resources.

The user device(s) 120 may be assigned one or more resource units or may randomly access the operating channel. It is understood that a resource unit may be bandwidth allocation on an operating channel in time and/or frequency domain. For example, with respect to the AP assigning resource units, in a frequency band of 20 MHz, there may be a total of nine resource units, each of the size of a basic resource unit of 26 frequency tones. The AP 102 may assign one or more of these resource units to one or more user device(s) 120 to transmit their uplink data.

In accordance with some IEEE 802.11 ax (HEW) embodiments, an AP 102 may operate as a master station which may be arranged to contend for a wireless medium (e.g., during a contention period) to receive exclusive control of the medium for an HEW control period. The master station may transmit an HEW master-sync transmission at the beginning of the HEW control period. During the HEW control period, HEW stations (e.g., user devices 120) may communicate with the master station in accordance with a non-contention-based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

Any of the communications networks 130 and 135 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennas. A communications antenna may be any suitable type of antenna corresponding to the communications protocols used by the user device(s) 120 (e.g., user devices 124, 126, and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., 124, 126, or 128) and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n), 5 GHz channels (e.g., 802.11n, 802.11 ac), or 60 GHZ channels (e.g., 802.11 ad). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

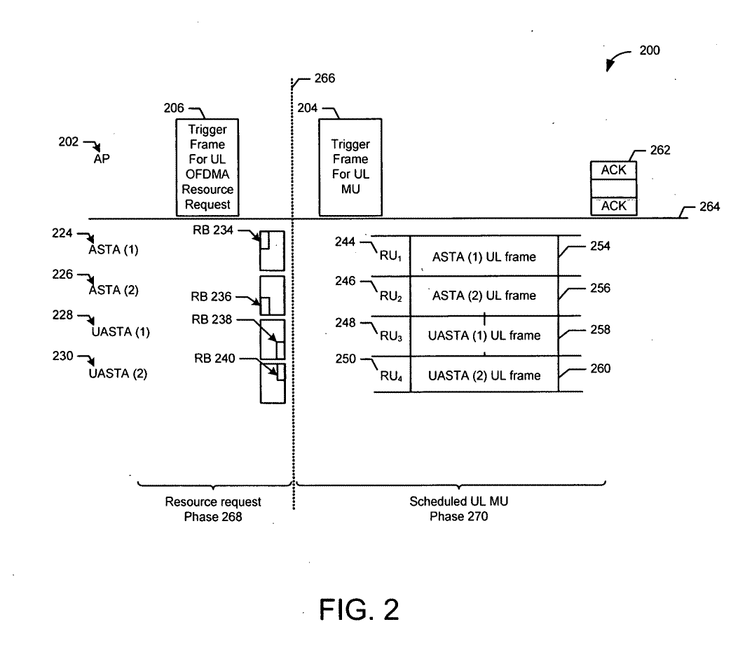

FIG. 2 depicts an illustrative schematic diagram of resource allocation in an OFDMA uplink resource allocation system, in accordance with one or more example embodiments of the present disclosure. In this illustrative example, an AP 202 may service one or more user devices. Transmissions sent from AP 202 may be depicted above line 264 and the transmission sent from the one or more stations may be depicted below line 264. Line 266 indicates a separation between Resource request Phase 268 and Scheduled UL MU Phase 270. The access point may send a trigger frame that may initiate one or more STAs to send a resource request during Resource request Phase 268 (left of line 266). In response, each of the one or more STAs may send a resource request during Resource request Phase 268. The access point may send another trigger frame in response to the received resource requests during Scheduled UL MU Phase 270. In response, each of the one or more STAs may send an UL frame using an RU (right of line 266). Each of the one or more user devices may be Assisted Stations (ASTA) or Unassisted Stations (USTA) (i.e., ASTA (1) 224, ASTA (2) 226, UASTA (1) 228, and UASTA (2) 230). Assigned (STAs) may be STAs that sent resource requests in a random UL OFDMA resource request phase prior to Resource Request Phase 268. Consequently, the assigned STAs may transmit their data before unassigned STAs transmit their data.

In one embodiment, AP 202 may send a trigger frame for UL OFDMA resource request 206 to one or more user devices (i.e., ASTA (1) 224, ASTA (2) 226, USTA (1) 228 and USTA (2) 230) if they want to transmit. The STAs that want a slot in Scheduled UL MU Phase 270 may send an UL OFDMA request in Resource request Phase 268. The STAs may send a UL OFDMA request by sending energy on an assigned resource block (RB) if the STA is associated or on a random RB if the STA is unassociated (associated STAs can also use the random mode). RB 234 may be an assigned resource block that ASTA (1) 224 transmits energy on, RB 236 may be an assigned resource block that ASTA (2) 226 transmits energy on, RB 238 may be a random resource block that UASTA (1) 228 transmits energy on, and RB 240 may be a random resource block that UASTA (2) 230 transmits energy on. The AP 202 may detect the STAs that sent energy on a resource block. The AP 202 may send a trigger frame for UL MU 204 opening the regular UL MU with the RU assigned to STAs that requested access. In some embodiments, the trigger frame may include an acknowledgement for channel access requests. Alternatively, resource request acknowledgment (ACK) 262 may be sent prior to the UL MU TF during Scheduled UL MU Phase 270.

ASTA (1) 224, ASTA (2) 226, UASTA (1) 228, and UASTA (2) 230 may send one or more UL frames during Scheduled UL MU Phase 270. ASTA (1) 224 may send ASTA (1) UL frame 254 using resource unit (RU) RU₁ 244, ASTA (2) 226 may send ASTA (2) UL frame 256 using RU₂ 246, UASTA (1) 228 may send UASTA (1) UL frame 258 using RU₃ 248, and UASTA (2) 230 may send UASTA (2) UL frame 260 using RU₄ 250.

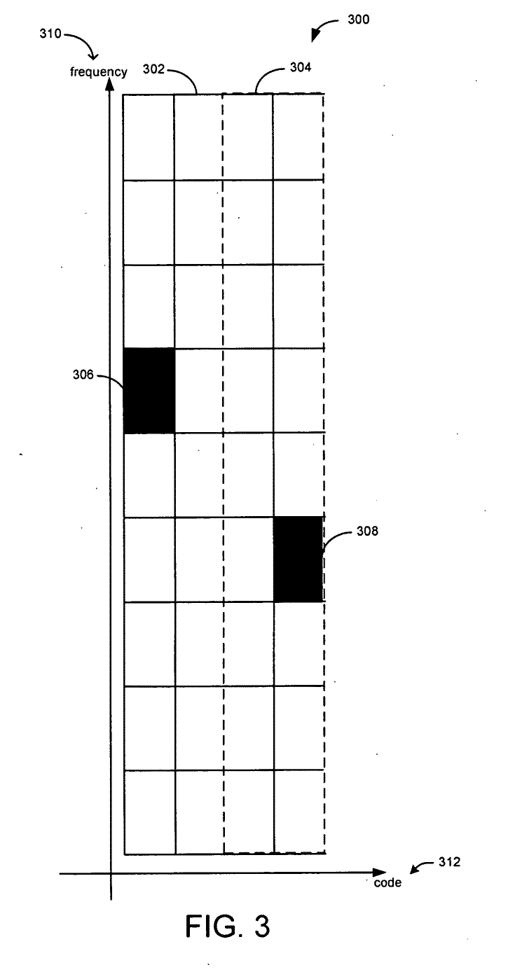

FIG. 3 depicts an illustrative schematic diagram of a resource block allocation, in accordance with one or more embodiments of the disclosure.

In OFDMA, the AP defines a frequency-code grid 300, where the column represents different codes (lines) of the P-matrix (used in HE-LTF), and there could be up to eight codes. Further, grid 300 may have lines representing resource units in the frequency domain (26 tone allocation for instance). The AP may define the number of columns. (among the possible configurations) and the number of lines (which are limited by the UL OFDMA designs (nine for 20 MHz, etc.)) and may signal this information to the STAs in beacons or control frames or in the trigger frame that initiates this resource request phase. The resource blocks may all be randomly selected by the STAs, or all resource blocks may be assigned to associated STAs. Some resource, blocks (e.g., blocks 302) are assigned to associated STAs, and some blocks (e.g., block 304) may be randomly selected.

FIG. 3 shows that part of the resource blocks are assigned to an associated STA. Each associated STA may have a unique resource block assigned by the AP. For example, block 306 may be assigned to a user device 120, and another part of the resource blocks may be assigned for random selection by unassociated STAs. For example, block 308 may be assigned to another user device 120. The AP may define and may advertise to the STAs (in Beacons, in control frames, or in the trigger frame that initiates this resource request phase) the group of resource blocks that are assigned for random selection. The AP may assign to each of these resource blocks a specific resource block ID (RBID). Frequency 310 may represent slots corresponding to one or more frequencies that may be used by the STAs to transmit data to an access point. Each of the one or more frequencies may correspond to a code. Code 312 may represent different slots corresponding to the codes.

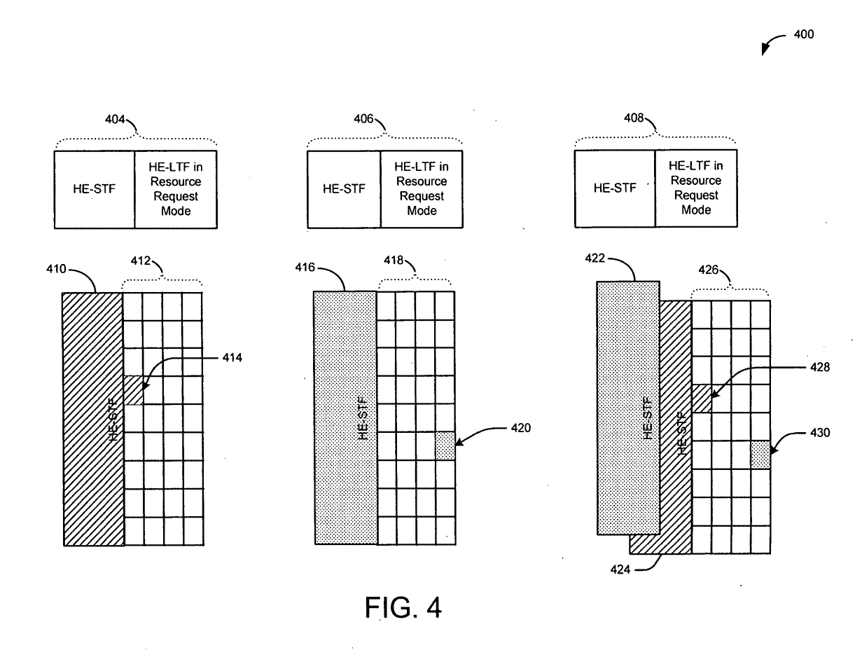

FIG. 4 depicts an illustrative transmission and reception of resource requests, in accordance with one or more embodiments of the disclosure.

In one embodiment, the STAs that want to transmit to the AP in a future UL multi-user (MU) phase may send in the first phase a UL OFDMA resource request frame. The STAs that have assigned RBIDs may use their RBIDs. The STAs that do not have assigned RBIDs may randomly select one. Each STA may transmit an HE-STF frame using bandwidth included in the resource request trigger frame, followed by an HE-LTF frame, transmitted on a resource unit and using a P-matrix code from the RBID (e.g., 404, 406, and 408). A first station (e.g., User Device 124) may transmit HE-STF frame 410 using RBID 414 in frequency code grid 412 to AP 102. A second station (e.g., User Device 126) may transmit HE-STF frame 416 using RBID 420 in frequency code grid 418 to AP 102. AP 102 may receive HE-STF frames 422 and 424, which correspond to HE-STF frames 410 and 416 sent by User Devices 124 and 126 respectively. Frequency code grid 426 may be a frequency code grid used by AP 102 to determine which RBID HE-STF 422 and 424 were received in. HE-STF 422 and 424 may be received in RBIDs 428 and 430 respectively. An RB may correspond to an RU and code from a P-matrix of any size including a 4×4 P-matrix, and may be assigned an ID as explained above thereby creating an RBID corresponding to an RU and code from the P-matrix. Each RU may comprise one or more frequencies. In some embodiments the one or more frequencies may comprise 26 unique tones, wherein none of the tones are multiples of any of the other tones. RBID 414 may correspond to a fourth RU and a first code from a P-matrix (e.g., a 4×4 P-matrix) in frequency code grid 412, and RBID 420 may correspond to a sixth RU and a fourth code from a P-matrix (e.g., a 4×4 P-matrix) in frequency code grid 420. Legacy preambles (Legacy-Shot Training Field (L-STF), Legacy-Long Training Field (L-LTF), and Legacy-Signal (SIG)) may be sent prior to the HE-STF. These fields are not shown in FIG. 4.

When AP 102 receives HE-STFs 422 and 424, AP 102 detects energy by correlating HE-STFs 422 and 424 with the different sequences of the P-matrix in the different resource units on all resource blocks. When AP 102 detects energy on RBIDs 428 and 430 assigned to User Devices 124 and 126, it knows that User Devices 124 and 126 have sent resource requests in HE-STFs 422 and 424 respectively. When the AP 102 detects energy on an RB used for random access, it notes the RBID and uses the RBID as the identifier for that STA.

In some embodiments, a near-far problem may exist between the AP and one or more STAs. A near-far problem may exist when multiple STAs are transmitting to the AP at various distances from the AP. Variations in distance from the AP may cause transmissions from the STAs to the AP to be received by the AP at different power levels. For example, a first transmission transmitted by a first STA nearby the AP may be received by the AP at a higher and/or sufficient power level, whereas a second transmission transmitted by a second STA that is farther away from the AP than the first STA may be received by the AP at a lower and/or insufficient power level. Accordingly, transmissions that are transmitted by the STAs that are located relatively far from the AP (e.g., outside a predetermined proximity to the AP) may not be acknowledged and/or correctly received by the AP due to a lower signal power of the transmissions.

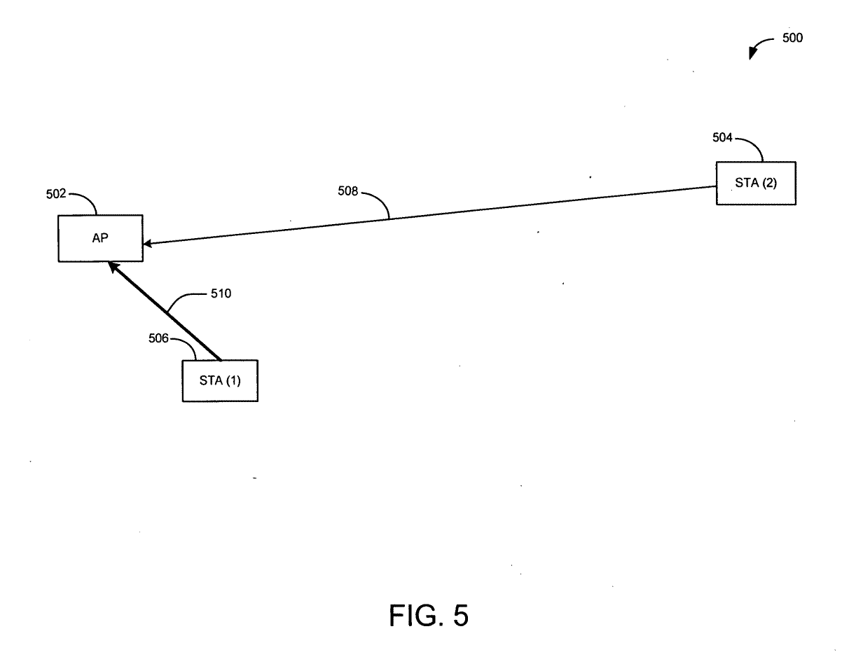

FIG. 5 depicts an illustrative system diagram 500 of an exemplary near-far problem between an access point and two wireless stations (e.g., user devices), according to one or more example embodiments of the disclosure. For example, STA (1) 506 is located closer to the AP 502 than STA (2) 504. As such, transmission 510 transmitted by STA (1) 506 to AP 502 may have a higher power (−55 dBm) than transmission 508 transmitted by STA (2) 504 to AP 502 (−75 dBm), and the AP 502 may have a difficult time correctly receiving the transmission transmitted by STA (2) 504.

In some embodiments, the AP may utilize various automatic gain control (AGC) techniques to attempt to regulate power levels of incoming transmissions. However, the application of these techniques may still not enable the AP to receive transmissions from transmitting STAs correctly, especially if multiple transmissions are received on the same frequency and/or resource unit.

Accordingly, the embodiments disclosed herein may be directed to utilizing a power control mechanism that enables the AP to transmit two pieces of information to each STA to guide adjustment of the transmitter power (e.g., power of transmissions transmitted by the STAs) in uplink (UL) multi-user (MU) transmissions. In this manner, the AP may not only communicate allocation information in a trigger frame to the STA(s), but may also communicate information associated with a target transmission power level for transmissions transmitted by the STAs (e.g., a target power level at which the AP may correctly receive transmissions transmitted by the STAs).

In some embodiments, the AP may transmit to the STAs information associated with a transmission power level of transmissions transmitted by the AP to the STA, as well as information associated with a transmission power level of transmissions transmitted by the STA to the AP (e.g., a receiving power level of the AP). The information may include a predetermined range of power levels that are acceptable (e.g., that enable the AP and/or the STA to correctly and accurately receive and/or transmit information). For example, a target receiving power level of the AP may include a power level at which the AP is to receive transmissions (e.g., signals) from each STA plus and/or minus a predetermined tolerated window (e.g., a few dBs). Using this information, each STA may be enabled to adapt its transmission power levels of transmissions sent to the AP in order to ensure that its transmission will be received by the AP at a desired target receiving power level.

In some embodiments, this information may be transmitted by the AP to the STAs in a trigger frame (e.g., a trigger frame that also includes allocation information, and/or the like) that is transmitted prior to any UL MU data transmissions. This information may also be transmitted in beacons broadcast before, during, and/or after transmission of the trigger frame and/or data transmissions, in AP capability advertisements, and/or the like.

For different UL MU transmissions (and especially for random access transmissions using Orthogonal Frequency-Division Multiple Access Distributed Channel Access (OCDA) and/or resource request access using HE-LTFs with assigned and/or random RBIDs), it may be important to ensure that all STAs that desire to communicate with the AP are enabled to participate. Accordingly, the AP may determine a predetermined proximity (e.g., distance range) to the AP within which all STAs located within the proximity are enabled to communicate with the AP. For example, all STAs located within the proximity may receive information associated with a desired receiving power level of the AP and information associated with a desired transmitting power level of each STA.

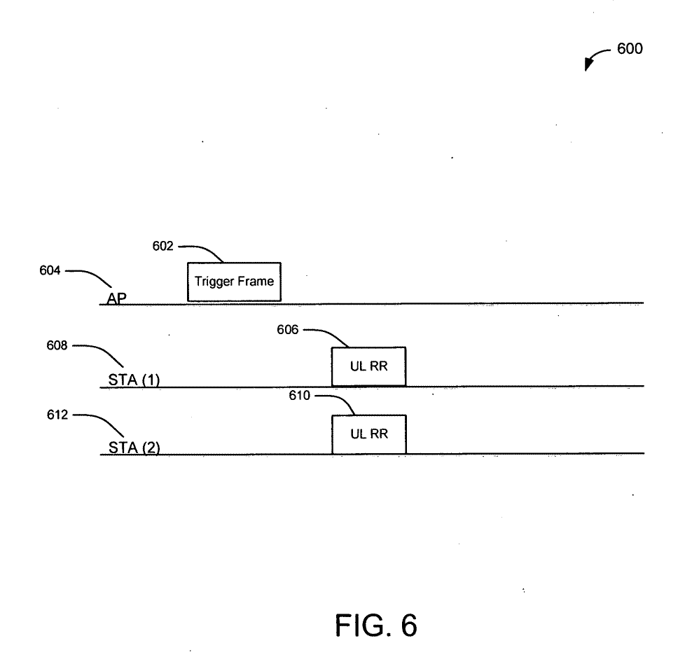

FIG. 6 depicts an illustrative transmission 600 of a two-part transmission transmitted from an access point to two wireless stations (e.g., user devices), according to one or more example embodiments of the disclosure. For example, the AP (e.g., AP 604) may transmit a trigger frame (e.g., Trigger Frame 602) that may include information associated with a transmission power level of the AP, as well as information associated with a target uplink receiving power level of the AP. The trigger frame may also include allocation information for transmitting data over a UL MU data transmission. In response to receiving the trigger frame (or upon initiation of a resource request phase in UL MU mode with HE-LTFs or initiation of a random access UL MU mode), each STA (e.g., STA (1) 608 and STA (2) 612) may transmit UL resource request data packets (e.g., UL RR 606 and 610) confirming receipt of the information associated with the target transmission and/or receiving power levels.

Further, using the information associated with the target transmission and/or receiving power levels, each STA may compute an attenuation of the established communication connection between the STA and the AP. For example, the attenuation may be computed by subtracting an estimated receiving power level of the AP (e.g., information received from the AP) from the AP's transmitting power level (e.g., information received from the AP). Assuming reciprocity of the communication connection, attenuation of the link (e.g., connection) from the STA to the AP may be the same as attenuation of the link from the AP to the STA.

Next, each STA may compute a transmission power level to be used to transmit UL MU data transmissions to the AP. In some embodiments, the STA transmission power level may be computed by adding a target UL receiving power level of the AP (e.g., information received from the AP) and the computed link attenuation value.

In some embodiments, the AP may desire to enable all STAs within a predetermined proximity to communicate with the AP (e.g., during UL MU resource requests and/or random access modes). Therefore, the AP may set a target receiving power level based on an amount of power required to accurately and/or correctly receive a transmission from an STA located farthest away in the predetermined proximity to the AP (e.g., an expected receiving power level at a range limit of the predetermined proximity). Accordingly, the STA that is farthest away may not have to change, a transmitting power level, while STAs closer to the AP than the farthest away STA may modify and/or adjust a transmitting power level.

In other embodiments, the AP may desire to restrict STA participation for a more efficient transmission so that particular STAs within various distances to the AP may communicate with the AP. For example, the AP may set a target receiving power level so that the AP selects the range at which STAs may participate in the following UL MU phase. In some instances, the AP may constrict the predetermined proximity to exclude STAs at and/or near the farthest limits of the proximity from participating. Accordingly, by selecting a distance and/or range associated with the proximity within which STAs may communicate with the AP, the AP may include and/or exclude different STAs from participation. In this manner, the AP may select and/or determine one or more STAs to be included in the predetermined proximity to the AP. For example, the AP may determine that only STAs within a predetermined distance of the AP may be enabled to communicate with the AP.

In alternative embodiments, the AP may desire to set a receiving power level to achieve a best efficiency (e.g., a highest rate) in the UL MU phase. For example, the AP may know exactly which STAs are nearby and are to be scheduled for communicating with the AP in a subsequent UL MU phase, as well as the receiving power level at which the AP will receive transmissions from each STA. Accordingly, the AP may set the target receiving power level in order to ensure that the AP is enabled to receive at a highest rate (e.g., of accuracy, of signal-to-noise ratio, and/or the like). In some embodiments, the AP may set the target receiving power level at a lowest receiving power level required to receive transmissions from the known STAs.

In order to provide some flexibility in the precision of the STA transmitting power, the AP may indicate in the trigger frame (or beacons, capabilities advertisements, and/or the like) a target receiving power level tolerance on the target receiving power level. For example, the AP may indicate a target receiving power level range of acceptable receiving power levels at which the AP can accurately receive transmissions from the STAs. In some embodiments, the AP may compute and/or determine a target receiving power level tolerance using a maximum power level difference between the STAs' UL receiving power levels that still can be decoded. Factors on which the maximum power level difference may be based may include if the STAs transmit on the same and/or adjacent resource units (e.g., frequency bands).

The STA(s) may then compute their transmitting power levels using the target receiving power level of the AP. For example, the STA may select a transmitting power level in a range of (calculated STA transmitting power level computed above—tolerance, calculated STA transmitting power level+tolerance). Assuming this tolerance, the previous strategy to set the target receiving power level of the AP as the receiving power level received from a farthest away STA may be modified to be set as the receiving power level of the farthest away associated STA +target tolerance.

While the information associated with the transmission power level, the target receiving power level, the target receiving power level range, and/or the target receiving power level tolerance may be transmitted from the AP to the STAs in the trigger frame, beacons, and/or AP capabilities advertisements, the AP may preferably transmit this information in the AP capabilities advertisements because the target receiving power levels may be dependent on the AP's capabilities. Further, the target receiving power level tolerance may be modified at different times to address the immediate needs of the AP. As such, the information associated with the target receiving power level tolerance may include different fields of information such as a target receiving p6wer level tolerance for UL OFDMA (e.g., a case where signals from different STAs are transmitted in different resource units), a target receiving power level tolerance for UL MU-MIMO (e.g., a case where signals from different STAs are in the same resource units using different spatial streams), and a target receiving power level tolerance for UL MU RR using HE-LTFs (e.g., a case where signals from different STAs are HE-LTF symbols, which may be transmitted using the same resource units and different spatial streams (assuming use of different RBIDs for each STA)).

Similarly, information associated with the target receiving power level may also be transmitted in different ways based on the needs of the AP. For example, the information associated with the target receiving power level may include different fields of information such as a target receiving power level for UL OFDMA (e.g., a case where signals from different STAs are transmitted in different resource units), a target receiving power level for UL MU-MIMO (e.g., a case where signals from different STAs are in the same resource units using different spatial streams), and a target receiving power level for UL MU RR using HE-LTFs (e.g., a case where signals from different STAs are HE-LTF symbols, which may be transmitted using the same resource units and different spatial streams (assuming use of different RBIDs for each STA)).

The information associated with the target receiving power level may be included in a trigger frame that is sent to the STAs from the AP just before the UL MU phase is initiated. Alternatively, the information associated with the target receiving power level may be included in beacons and/or AP capabilities advertisements. Different target receiving power levels for different modes may be indicated using different identifications (IDs) associated with each target receiving power level. The AP may then simply indicate and/or signal an ID in a trigger frame that is sent prior to the UL MU phase being initiated. Alternatively, the AP may assign and/or define different group IDs for different groups of STAs. These group IDs may similarly be indicated in the trigger frame.

In some embodiments, the AP may determine the location of each STA using an Internet Protocol (IP) address, a device ID, global positioning system (GPS) coordinates, and/or the like. Similarly, each STA may determine the location of the AP. Further, power levels may be determined and/or calculated based on an amount of time required to transmit a signal from the STA to the AP and/or vice versa.

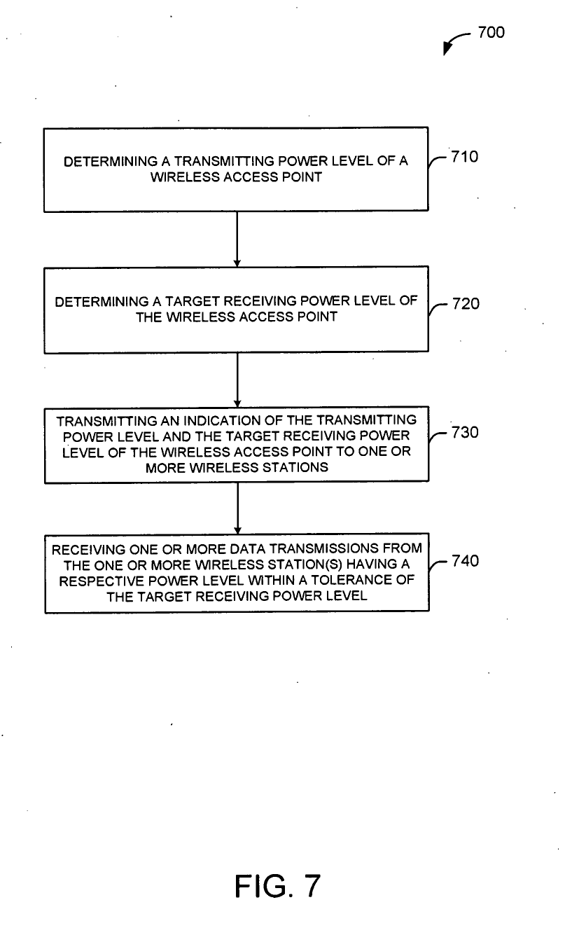

FIG. 7 depicts an illustrative process flow for utilizing the power control procedures described herein, according to one or more example embodiments of the disclosure. In some embodiments, a provided method 700 may include, at block 710, determining a transmitting power level of a wireless access point. At block 720, the method 700 may include determining a target receiving power level of the wireless access point. At block 730, the method may include transmitting an indication of the transmitting power level and the target receiving power level of the access point to one or more wireless stations. At block 740, the method may include receiving one or more data transmissions' from the one or more wireless stations, wherein the transmissions have a respective power level within a tolerance of the target receiving power level.

The blocks in method 700 may not occur in the order described above. For example, in some embodiments, block 720 may occur before block 710. In other embodiments, blocks 710 and 720 may occur at the same time. Consequently, the order of the blocks in method 700 may occur in any order and may be modified in any way to ensure logical continuity between the blocks.

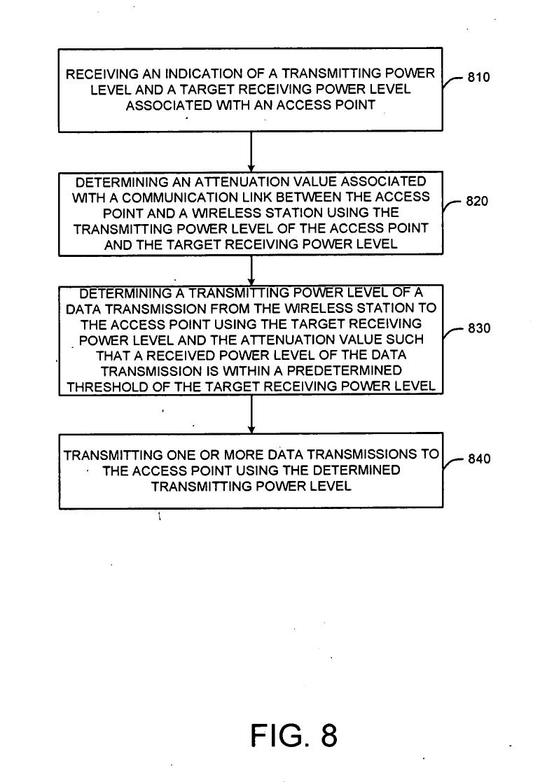

FIG. 8 depicts an illustrative process flow for utilizing the power control procedures described herein, according to one or more example embodiments of the disclosure. In some embodiments, a provided method 800 may include, at block 810, receiving an indication of a transmitting power level and a target receiving power level associated with an access point. At block 820, the method 800 may include determining an attenuation value associated with a communication link between the access point and a wireless station using the transmitting power level of the access point and the target receiving power level. The attenuation may be determined by the wireless station or access point. The attenuation may be characterized by one or more functions determining the metrics for one or more communication channels (i.e., communication links) established between the access point and wireless stations. In some embodiments the access point and/or wireless stations may use a High Efficiency Long Training Field (HE-LTF) or High Efficiency Short Training Field (HE-STF) in a trigger frame and uplink resource request to train a processor in the access point and wireless station to adjust one or more parameters of the one or more functions such that the processors can adjust settings in a transceiver in each respective device (i.e., the access point and wireless stations) to reduce attenuation.

At block 830, the method may include determining a transmitting power level of a data transmission from the wireless station to the access point using the target receiving power level and the attenuation value such that a received power level of the data transmission is within a predetermined threshold of the target receiving power level. After the transmitting power level has been determined, the method may proceed to transmitting one or more data transmissions to the access point using the determined transmitting power level (block 840).

The blocks in method 800 may not occur in the order described above. In some embodiments blocks 810-830 may occur simultaneously. For instance, as the wireless station receives the indication of a target receiving power level, it may simultaneously determine a transmitting power level to transmit the data transmissions and transmit one or more data transmissions. For example, if the target receiving power level associated with the access point is received in a downlink (DL) frame before the transmitting power level of the access point, the wireless station may simultaneously determine a transmitting power level of the wireless station and transmit one or more data transmissions as the remainder of the DL frame containing the transmitting power level of the access point is received. Consequently, the order of the blocks in method 800 may occur in any order and may be modified in any way to ensure logical continuity between blocks.

FIG. 9 illustrates a block diagram of an example embodiment 900 of a computing device 900 that can operate in accordance with at least certain aspects of the disclosure. In one aspect, the computing device 900 can operate as a wireless device and can embody or can comprise an access point (e.g., access point 102), a mobile computing device (e.g., user device 120), a receiving and/or a transmitting station, and/or other types of communication devices that can transmit and/or receive wireless communications in accordance with this disclosure. To permit wireless communication, including dynamic bit mapping techniques as described herein, the computing device 900 includes a radio unit 914 and a communication unit 926. In certain implementations, the communication unit 926 can generate data packets or other types of information blocks via a network stack, for example, and can convey data packets or other types of information blocks to the radio unit 914 for wireless communication. In one embodiment, the network stack (not shown) can be embodied in or can constitute a library or other types of programming modules, and the communication unit 926 can execute the network stack in order to generate a data packet or another type of information block (e.g., a trigger frame). Generation of a data packet or an information block can include, for example, generation of control information (e.g., checksum data, communication address(es)), traffic information (e.g., payload data), scheduling information (e.g., station information, allocation information, and/or the like), an indication, and/or formatting of such information into a specific packet header and/or preamble.

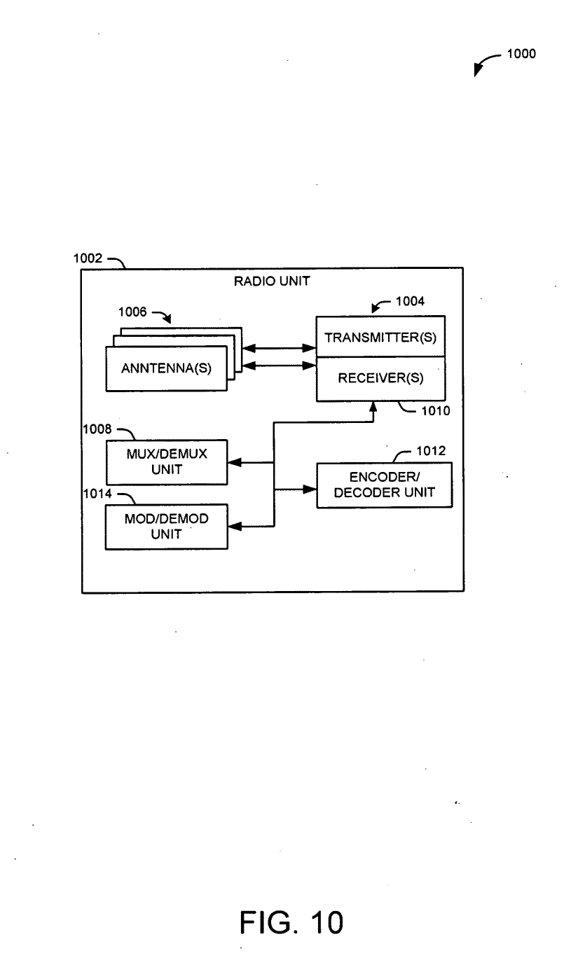

As illustrated, the radio unit 914 can include one or more antennas 916 and a multi-mode communication processing unit 918. In certain embodiments, the antenna(s) 916 can be embodied in or can include directional or omnidirectional antennas, including, for example, dipole antennas, monopole antennas, patch antennas, loop antennas, microstrip antennas, or other types of antennas suitable for the transmission of RF signals. In addition, or in other embodiments, at least some of the antenna(s) 916 can be physically separated to leverage spatial diversity and related different channel characteristics associated with such diversity. In addition or in other embodiments, the multi-mode communication processing unit 918 can process at least wireless signals in accordance with one or more radio technology protocols and/or modes (such as MIMO, MU-MIMO (e.g., multiple user-MIMO), single-input-multiple-output (SIMO), multiple-input-single-output (MISO), and the like. Each of such protocol(s) can be configured to communicate (e.g., transmit, receive, or exchange) data, metadata, and/or signaling over a specific air interface. The one or more radio technology protocols can include 3GPP UMTS; LTE; LTE-A; Wi-Fi protocols, such as those of the Institute of Electrical and Electronics Engineers (IEEE) 802.11 family of standards; Worldwide Interoperability for Microwave Access (WiMAX); radio technologies and related protocols for ad hoc networks, such as Bluetooth or ZigBee; other protocols for packetized wireless communication; or the like). The multi-mode communication processing unit 918 also can process non-wireless signals (analogic, digital, a combination thereof, or the like). In one embodiment (e.g., radio unit 1002 shown in FIG. 10), the multi-mode communication processing unit 918 can comprise a set of one or more transmitters 1004/receivers 1010, and components therein (amplifiers, filters, analog-to-digital (A/D) converters, etc.), functionally coupled to a multiplexer/demultiplexer (mux/demux) unit 1008, a modulator/demodulator (mod/demod) unit 1016 (also referred to as modem 1016), and an encoder/decoder unit 1012 (also referred to as codec 1012). Each of the transmitter(s)/receiver(s) can form respective transceiver(s) that can transmit and receive wireless signals (e.g., streams, electromagnetic radiation) via the one or more antennas 916. It should be appreciated that in other embodiments, the multi-mode communication processing unit 918 can include other functional elements, such as one or more sensors, a sensor hub, an offload engine or unit, a combination thereof, or the like.

Electronic components and associated circuitry, such as mux/demux unit 1008, codec 1012, and modem 1016 can permit or facilitate processing and manipulation, e.g., coding/decoding, deciphering, and/or modulation/demodulation of signal(s) received by the computing device 900 and the signal(s) to be transmitted by the computing device 900. In one aspect, as described herein, received and transmitted wireless signals can be modulated and/or coded, or otherwise processed, in accordance with one or more radio technology protocols. Such radio technology protocol(s) can include 3GPP UMTS; 3GPP LTE; LTE-A; Wi-Fi protocols, such as IEEE 802.11 family of standards (IEEE 802.ac, IEEE 802.ax, and the like); WiMAX; radio technologies and related protocols for ad hoc networks, such as Bluetooth or ZigBee; other protocols for packetized wireless communication; or the like.

The electronic components in the described communication unit, including the one or more transmitters 1004/receivers 1010, can exchange information (e.g., data packets, allocation information, data, metadata, code instructions, signaling and related payload data, multicast frames, combinations thereof, or the like) through a bus 1014, which can embody or can comprise at least one of a system bus, an address bus, a data bus, a message bus, a reference link or interface, a combination thereof, or the like. Each of the one or more transmitters 1004/receivers 1010 can convert signals from analog to digital and vice versa. In addition or in the alternative, transmitter(s) 1004/receiver(s) 1010 can divide a single data stream into multiple parallel data streams, or perform the reciprocal operation. Such operations may be conducted as part of various multiplexing schemes. As illustrated, the mux/demux unit 1008 is functionally coupled to the one or more transmitters 1004/receivers 1010 and can permit processing of signals in the time and frequency domain. In one aspect, the mux/demux unit 1008 can multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), or space division multiplexing (SDM). In addition or in the alternative, in another aspect, the mux/demux unit 1008 can scramble and spread information (e.g., codes) according to most any code, such as Hadamard-Walsh codes, Baker codes, Kasami codes, polyphase codes, and the like. The modem 1016 can modulate and demodulate information (e.g., data, metadata, signaling, or a combination thereof) according to various modulation techniques, such as OFDMA, OCDA, ECDA, frequency modulation (e.g., frequency-shift keying), amplitude modulation (e.g., M-ary quadrature amplitude modulation (QAM), with M a positive integer; amplitude-shift keying (ASK), phase-shift keying (PSK), and the like). In addition, the processor(s) that can be included in the computing device 900 (e.g., processor(s) included in the radio unit 914 or other functional element(s) of the computing device 900) can permit processing data (e.g., symbols, bits, or chips) for multiplexing/demultiplexing, modulation/demodulation (such as implementing direct and inverse fast Fourier transforms), selection of modulation rates, selection of data packet formats, inter-packet times, and the like.

The codec 1012 can operate on information (e.g., data, metadata, signaling, or a combination thereof) in accordance with one or more coding/decoding schemes suitable for communication, at least in part, through the one or more transceivers formed from respective transmitter(s)1004/receiver(s) 1010. In one aspect, such coding/decoding schemes, or related procedure(s), can be retained as a group of one or more computer-accessible instructions (computer-readable instructions, computer-executable instructions, or a combination thereof) in one or more memory devices 934 (referred to as memory 934). In a scenario in which wireless communication among the computing device 900 and another computing device (e.g., an access point 102, a user device 120, and/or other types of user equipment) utilizes MU-MIMI, MIMO, MISO, SIMO, or SISO operation, the codec 1012 can implement at least one of space-time block coding (STBC) and associated decoding, or space-frequency block coding (SFBC) and associated decoding. In addition or in the alternative, the codec 1012 can extract information from data streams coded in accordance with a spatial multiplexing scheme. In one aspect, to decode received information (e.g., data, metadata, signaling, or a combination thereof), the codec 1012 can implement at least one of computation of log-likelihood ratios (LLRs) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 1012 can utilize, at least in part, mux/demux unit 1008 and mod/demod unit 1016 to operate in accordance with the aspects described herein.

The computing device 900 can operate in a variety of wireless environments having wireless signals conveyed in different electromagnetic radiation (EM) frequency bands and/or subbands. To at least such end, the multi-mode communication processing unit 918 in accordance with aspects of the disclosure can process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion(s) of the EM spectrum. In one aspect, the set of one or more frequency bands can include at least one of (i) all or most licensed EM frequency bands, (such as the industrial, scientific, and medical (ISM) bands, including the 2.4 GHz band or the 5 GHz band); or (ii) all or most unlicensed frequency bands (such as the 60 GHz band) currently available for telecommunication.

The computing device 900 can receive and/or transmit information encoded and/or modulated or otherwise processed in accordance with aspects of the present disclosure. To at least such an end, in certain embodiments, the computing device 900 can acquire or otherwise access information, wirelessly via the radio unit 914 (also referred to as the radio 914), where at least a portion of such information can be encoded and/or modulated in accordance with the aspects described herein. More specifically, for example, the information can include prefixes, data packets, and/or physical layer headers (e.g., preambles and included information such as allocation information), a signal, and/or the like in accordance with embodiments of the disclosure, such as those shown in FIGS. 1-8.

The memory 934 can contain one or more memory elements having information suitable for processing information received according to a predetermined communication protocol (e.g., IEEE 802.11ac or IEEE 802.11ax). While not shown, in certain embodiments, one or more memory elements of the memory 934 can include computer-accessible instructions that can be executed by one or more of the functional elements of the computing device 900 in order to implement at least some of the functionality for the power control described herein, including the processing of information communicated (e.g., encoded, modulated, and/or arranged) in accordance with aspects of the disclosure. One or more groups of such computer-accessible instructions can embody or can constitute a programming interface that can permit the communication of information (e.g., data, metadata, and/or signaling) between functional elements of the computing device 900 for implementation of such functionality.

In addition, in the illustrated computing device 900, a bus architecture 942 (also referred to as bus 942) can permit the exchange of information (e.g., data, metadata, and/or signaling) between two or more of (i) the radio unit 914 or a functional element therein, (ii) at least one of the I/O interface(s) 922, (iii) the communication unit 926, or (iv) the memory 934. In addition, one or more application programming interfaces (APIs) (not depicted in FIG. 9) or other types of programming interfaces that can permit the exchange of information (e.g., trigger frames, streams, data packets, allocation information, data and/or metadata) between two or more of the functional elements of computing device 900. At least one of such API(s) can be retained or otherwise stored in the memory 934. In certain embodiments, it should be appreciated that at least one of the API(s) or other programming interfaces can permit the exchange of information within components of the communication unit 926. The bus 942 also can permit a similar exchange of information.

FIG. 11 illustrates an example of a computational environment 1100 for power control in accordance with one or more aspects of the disclosure. The example computational environment 1100 is only illustrative and is not intended to suggest or otherwise convey any limitation as to the scope of use or functionality of such computational environment's architecture. In addition, the computational environment 1100 should not be interpreted as having any dependency or requirement relating to any one or combination of components illustrated in this example computational environment. The illustrative computational environment 1100 can embody or can include, for example, computing device 900, an access point 102, a user device 120, and/or any other computing device that can implement or otherwise leverage the power control features described herein.

The computational environment 1100 represents an example of a software implementation of the various aspects or features of the disclosure in which the processing or execution of the operations described in connection with the power control described herein, including the processing of information communicated (e.g., encoded, modulated, and/or arranged) in accordance with this disclosure, can be performed in response to the execution of one or more software components at the computing device 1110. It should be appreciated that the one or more software components can render the computing device 1110, or any other computing device that contains such components, a particular machine for the power control described herein, including the processing of information encoded, modulated, and/or arranged in accordance with the aspects described herein, among other functional purposes. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can be assembled into one or more program modules, for example, that can be compiled, linked, and/or executed at the computing device 1110 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 1110 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with power control, including the processing of information communicated (e.g., encoded, modulated, and/or arranged) in accordance with the features described herein, can comprise personal computers; server computers; laptop devices; handheld computing devices, such as mobile tablets; wearable computing devices; and multiprocessor systems. Additional examples can include set-top boxes, programmable consumer electronics, network PCs, minicomputers, mainframe computers, blade computers, programmable logic controllers, distributed computing environments that comprise any of the above systems or devices, and the like.

As illustrated, the computing device 1110 can comprise one or more processors 1114, one or more input/output (I/O) interfaces 1116, a memory 1130, and a bus architecture 1132 (also termed bus 1132) that functionally couples various functional elements of the computing device 1110. The bus 1132 can include at least one of a system bus, a memory bus, an address bus, or a message bus, and can permit the exchange of information (data, metadata, and/or signaling) between the processor(s) 1114, the I/O interface(s) 1116, and/or the memory 1130, or the respective functional elements therein. In certain scenarios, the bus 1132 in conjunction with one or more internal programming interfaces 1150 (also referred to as interface(s) 1150) can permit such exchange of information. In scenarios in which the processor(s) 1114 include multiple processors, the computing device 1110 can utilize parallel computing.

The I/O interface(s) 1116 can permit or otherwise facilitate the communication of information between the computing device and an external device, such as another computing device, e.g., a network element or an end-user device. Such communication can include direct communication or indirect communication, such as the exchange of information between the computing device 1110 and the external device via a network or elements thereof As illustrated, the I/O interface(s) 1116 can comprise one or more of network adapter(s) 1118, peripheral adapter(s) 1122, and display unit(s) 1126. Such adapter(s) can permit or facilitate connectivity between the external device and one or more of the processor(s) 1114 or the memory 1130. In one aspect, at least one of the network adapter(s) 1118 can couple functionally the computing device 1110 to one or more computing devices 1170 via one or more traffic and signaling pipes 160 that can permit or facilitate exchange of traffic 1162 and signaling 1164 between the computing device 1110 and the one or more computing devices 1170. Such network coupling provided at least in part by the at least one of the network adapter(s) 1118 can be implemented in a wired environment, a wireless environment, or both. The information that is communicated by the at least one network adapter can result from the implementation of one or more operations in a method of the disclosure. Such output can be any form of visual representation including, but not limited to, textual, graphical, animation, audio, tactile, and the like. In certain scenarios, each access point 102, user device 120, station, and/or other device can have substantially the same architecture as the computing device 1110. In addition or in the alternative, the display unit(s) 1126 can include functional elements (e.g., lights, such as light-emitting diodes; a display, such as a liquid crystal display (LCD), combinations thereof, or the like) that can permit control of the operation of the computing device 1110, or can permit conveying or revealing the operational conditions of the computing device 1110.

Radio Unit 1120 may comprise one or more processors, transceivers, and antennas communicatively coupled to the one or more processors and transceivers. Radio Unit 1120 may transmit and receive signals using the antenna and transceiver.

In one aspect, the bus 1132 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, a Universal Serial Bus (USB), and the like. The bus 1132, and all buses described herein, can be implemented over a wired or wireless network connection, and each of the subsystems, including the processor(s) 1114, the memory 1130 and memory elements therein, and the I/O interface(s) 1116 can be contained within one or more remote computing devices 1170 at physically separate locations, connected through buses of this form, in effect implementing a fully distributed system.

The computing device 1110 can comprise a variety of computer-readable media. Computer-readable media can be any available media (and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 1110, and can comprise, for example, both volatile and non-volatile media, and removable and/or non-removable media. In one aspect, the memory 1130 can comprise computer-readable media in the form of volatile memory, such as random access memory (RAM), and/or non-volatile memory, such as read-only memory (ROM).

The memory 1130 can comprise functionality instructions storage 1134 and functionality information storage 1138. The functionality instructions storage 1134 can comprise computer-accessible instructions that, in response to execution (by at least one of the processor(s) 1114), can implement one or more of the functionalities of the disclosure. The computer-accessible instructions can embody or can comprise one or more software components illustrated as power control component(s) 1136. In one scenario, execution of at least one component of the power control component(s) 1136 can implement one or more of the techniques disclosed herein. For instance, such execution can cause a processor that executes the at least one component to carry out a disclosed example method. It should be appreciated that, in one aspect, a processor of the processor(s) 1114 that executes at least one of the power control component(s) 1136 can retrieve information from or retain information in a memory element 1140 (referred to as power control information 1140) in the functionality information storage 1138 in order to operate in accordance with the functionality programmed or otherwise configured by the power control component(s) 1136. Such information can include at least one of code instructions, information structures, or the like. At least one of the one or more interfaces 1150 (e.g., application programming interface(s)) can permit or facilitate the communication of information between two or more components within the functionality instructions storage 1134. The information that is communicated by the at least one interface can result from implementation of one or more operations in a method of the disclosure. In certain embodiments, one or more of the functionality instructions storage 1134 and the functionality information storage 1138 can be embodied in or can comprise removable/non-removable, and/or volatile/non-volatile computer storage media.

At least a portion of at least one of the power control component(s) 1136 or power control information 1140 can program or otherwise configure one or more of the processors 1114 to operate at least in accordance with the functionality described herein. One or more of the processor(s) 1114 can execute at least one of such components and leverage at least a portion of the information in the functionality information storage 1138 in order to provide power control in accordance with one or more aspects described herein. More specifically, yet not exclusively, execution of the one or more of the power control component(s) 1136 can permit transmitting and/or receiving information at computing device 1110, as described in connection with FIGS. 1-8, for example.

It should be appreciated that, in certain scenarios, the functionality instruction(s) storage 1134 can embody or can comprise a computer-readable non-transitory storage medium having computer-accessible instructions that, in response to execution, cause at least one processor (e.g., one or more of the processor(s) 1114) to perform a group of operations comprising the operations or blocks described in connection with the disclosed methods.

In addition, the memory 1130 can comprise computer-accessible instructions and information (e.g., data and/or metadata) that permit or facilitate the operation and/or administration (e.g., upgrades, software installation, any other configuration, or the like) of the computing device 1110. Accordingly, as illustrated, the memory 1130 can comprise a memory element 1142 (labeled OS instruction(s) 1142) that contains one or more program modules that embody or include one or more operating systems, such as Windows operating system, Unix, Linux, Symbian, Android, Chromium, and substantially any operating system suitable for mobile computing devices or tethered computing devices. In one aspect, the operational and/or architectural complexity of the computing device 1110 can dictate a suitable operating system. The memory 1130 also comprises a system information storage 1146 having data and/or metadata that permits or facilitates the operation and/or administration of the computing device 1110. Elements of the OS instruction(s) 1142 and the system information storage 1146 can be accessible or can be operated on by at least one of the processor(s) 1114.

It should be recognized that while the functionality instructions storage 1134 and other executable program components, such as the OS instruction(s) 1142, are illustrated herein as discrete blocks, such software components can reside at various times in different memory components of the computing device 1110, and can be executed by at least one of the processor(s) 1114. In certain scenarios, an implementation of the power control component(s) 1136 can be retained on or transmitted across some form of computer-readable media.

The computing device 1110 and/or one of the computing device(s) 1170 can include a power supply (not shown), which can power up components or functional elements within such devices. The power supply can be a rechargeable power supply, e.g., a rechargeable battery, and it can include one or more transformers to achieve a power level suitable for operation of the computing device 1110 and/or one of the computing device(s) 1170, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 1118) to connect operationally to the conventional power grid. In another aspect, the power supply can include an energy conversion component, such as a solar panel, to provide additional or alternative power resources or autonomy for the computing device 1110 and/or one of the computing device(s) 1170.

The computing device 1110 can operate in a networked environment by utilizing connections to one or more remote computing devices 1170. As an illustration, a remote computing device can be a personal computer, a portable computer, a server, a router, a network computer, a peer device or other common network node, and so on. As described herein, connections (physical and/or logical) between the computing device 1110 and a computing device of the one or more remote computing devices 1170 can be made via one or more traffic and signaling pipes 1160, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

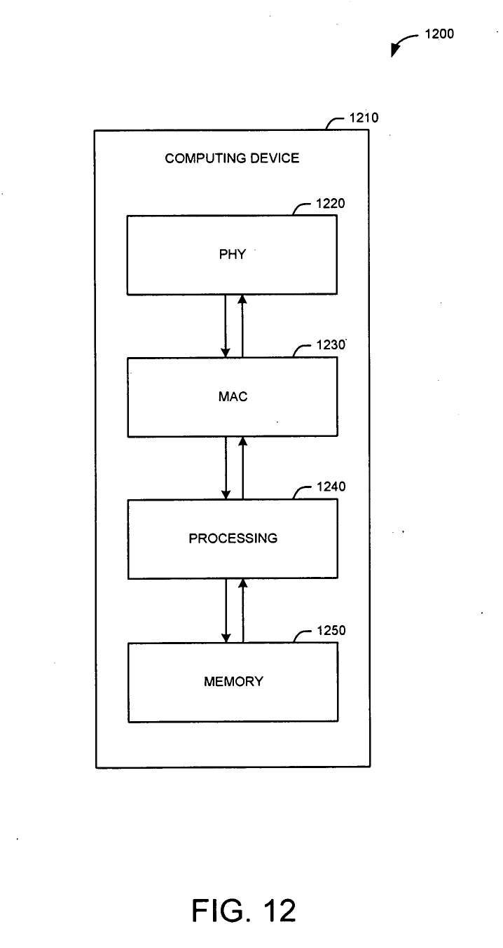

FIG. 12 presents another example embodiment 1200 of a computing device 1210 in accordance with one or more embodiments of the disclosure. In certain implementations, the computing device 1210 can be a HEW-compliant device that may be configured to communicate with one or more other HEW devices and/or other types of communication devices, such as legacy communication devices. HEW devices and legacy devices also may be referred to as HEW stations (STAs) and legacy STAs, respectively. In one implementation, the computing device 1210 can operate as an access point 102, a user device 120, and/or another device. As illustrated, the computing device 1210 can include, among other things, physical layer (PHY) circuitry 1220 and medium-access-control layer (MAC) circuitry 1230. In one aspect, the PHY circuitry 1210 and the MAC circuitry 1230 can be HEW compliant layers and also can be compliant with one or more legacy IEEE 802.11 standards. In one aspect, the MAC circuitry 1230 can be arranged to configure physical layer converge protocol (PLCP) protocol data units (PPDUs) and arranged to transmit and receive PPDUs, among other things. In addition or in other embodiments, the computing device 1210 also can include other hardware processing circuitry 1240 (e.g., one or more processors) and one or more memory devices 1250 configured to perform the various operations described herein.

In certain embodiments, the MAC circuitry 1230 can be arranged to contend for a wireless medium during a contention period to receive control of the medium for the HEW control period and configure an HEW PPDU. In addition or in other embodiments, the PHY 1220 can be arranged to transmit the HEW PPDU. The PHY circuitry 1220 can include circuitry for modulation/demodulation, upconversion/downconversion, filtering, amplification, etc. As such, the computing device 1210 can include a transceiver to transmit and receive data such as HEW PPDU. In certain embodiments, the hardware processing circuitry 1240 can include one or more processors. The hardware processing circuitry 1240 can be configured to perform functions based on instructions being stored in a memory device (e.g., RAM or ROM) or based on special purpose circuitry. In certain embodiments, the hardware processing circuitry 1240 can be configured to perform one or more of the functions described herein, such as activating and/or deactivating different back-off count procedures, allocating bandwidth, and/or the like.

In certain embodiments, one or more antennas may be coupled to or included in the PHY circuitry 1220. The antenna(s) can transmit and receive wireless signals, including transmission of HEW packets. As described herein, the one or more antennas can include one or more directional or omnidirectional antennas, including dipole antennas, monopole antennas, patch antennas, loop antennas, microstrip antennas, or other types of antennas suitable for the transmission of RF signals. In scenarios in which MIMO communication is utilized, the antennas may be physically separated to leverage spatial diversity and the different channel characteristics that may result.

The memory 1250 can retain or otherwise store information for configuring the other circuitry to perform operations for configuring and transmitting HEW packets and performing the various operations described herein including the allocation and useof bandwidth (AP) and using the allocation of the bandwidth (STA).

The computing device 1210 can be configured to communicate using OFDM communication signals over a multicarrier communication channel. More specifically, in certain embodiments, the computing device 1210 can be configured to communicate in accordance with one or more specific radio technology protocols, such as the IEEE family of standards including IEEE 802.11-2012, IEEE 802.11n-2009, IEEE 802.11 ac-2013, IEEE 802.11 ax, DensiFi, and/or proposed specifications for WLANs. In one of such embodiments, the computing device 1210 can utilize or otherwise rely on symbols having a duration that is four times the symbol duration of IEEE 802.11n and/or IEEE 802.11ac. It should be appreciated that the disclosure is not limited in this respect and, in certain embodiments, the computing device 1210 also can transmit and/or receive wireless communications in accordance with other protocols and/or standards.

The computing device 1210 can be embodied in or can constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11 or IEEE 802.16, or other types of communication devices that may receive and/or transmit information wirelessly. Similar to computing device 1110, computing device 1210 can include, for example, one or more of a keyboard, a display, a non-volatile memory port, multiple antennas, a graphics processor, an application processor, speakers, and other mobile device elements. The display may be an LCD screen including a touch screen.

It should be appreciated that while the computing device 1210 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In certain embodiments, the functional elements may refer to one or more processes operating or otherwise executing on one or more processors.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

In example embodiments of the disclosure, there may be a device that includes among other things, at least one processor; and at least one memory that stores computer-executable instructions, wherein the at least one processor is configured to access the at least one memory and execute the computer-executable instructions to identify a trigger frame received on the communication channel from the computing device. The device may determine an uplink frame to be sent to a computing device on a communication channel. The device may identify one or more random access resource allocations, wherein the one or more random access resource allocations are associated with the trigger frame. The device may assign a respective numerical value to each of the one or more random access resource allocations. The device may select a numerical value based at least in part on a probability distribution. The device may determine a particular resource allocation of the one or more random access resource allocations that corresponds to the numerical value. The device may cause the uplink frame to be sent to the computing device using the particular resource allocation.

Implementations may include one or more of the following features. The device may further include one or more transceivers configured to transmit and receive signals. The device may further include at least one antenna electrically coupled to each of the one or more transceivers. The one or more random access resource allocations may be frequency channel resource allocations and spatial stream resource allocations. The frequency channel resource allocations may comprise nine frequencies. The spatial stream resource allocations may correspond to a code. Each code may be orthogonal to each of the other codes. The at least one processor may be further configured to determine a backoff count, wherein the backoff count is based at least in part on an integer value associated with Orthogonal Frequency Division Multiple Access (OFDMA); and decrement the backoff count by an integer representative of a number of the one or more random resource allocations. The integer value may be a Contention window (CW) for Orthogonal Frequency Division Multiplex (OFDM). The spatial stream resource allocations may comprise eight spatial streams. The at least one processor may be further configured to execute the computer-executable instructions to identify, in response to sending the uplink frame, an acknowledgment from the computing device. The backoff count may be initialized to a random integer value between 0 and the CW.

In some embodiments, a non-transitory computer-readable medium storing computer-executable instructions which, when executed by a processor, may cause the processor to perform operations comprising: determining at least one random access resource allocation, wherein each of the at least one random access resource allocations include a frequency resource allocation and a spatial stream resource allocation; generating a trigger frame associated with the at least one random access resource allocation; causing the trigger frame to be sent to at least one user device; and receiving from the at least one user device, in response to the trigger frame, an uplink frame on one of the frequency resource allocations and one of the spatial stream resource allocations.

The one of the frequency resource allocations and the one of the spatial stream resource allocations may be randomly selected by each of the at least one user device. The one of the frequency resource allocations and the one of the spatial stream resource allocations may be based at least in part on a backoff count associated with each of the at least one user device. The backoff count may be initialized to a random integer value between 0 and a contention window (CW) for Orthogonal Frequency Division Multiple Access (OFDMA). The computer-executable instructions may cause the processor to further perform operations comprising: sending, in response to receiving the uplink frame, an acknowledgment to each of the at least one user device. The at least one random access resource allocation may include at least one of a random access trigger frame identifier, an Association Identifier (AID) equal to 0, or an AID not associated with the at least one user device. The frequency resource allocations and the one of the spatial stream resource allocations may be associated with the backoff count being equal to a first integer. The backoff count may be re-initialized to a random integer value between 0 and CW0 after receiving the uplink frame from the at least one user device.

In some embodiments, there may be a method comprising: determining, by a computing device comprising a processor and one or more transceiver components, at least one random access resource allocation, wherein each of the at least one random access resource allocations include a frequency resource allocation and a spatial stream resource allocation; generating a trigger frame associated with the at least one random access resource allocation; causing, by the computing device, the trigger frame to be sent to the at least one user device; and receiving, by the computing device, from the at least one user device, in response to sending the trigger frame, an uplink frame corresponding to the frequency resource allocation and the spatial stream resource allocation.

Implementations may include the following features. The at least one random access resource allocation may be based at least in part on the Orthogonal Frequency Division Multiple Access (OFDMA) standard. The method may further include sending, in response to receiving the uplink frames from the at least one user device, an acknowledgment to the at least one user device. The at least one random access resource allocation may include at least one of a random access trigger frame identifier, an Association Identifier (AID) equal to 0, or an AID not associated with the at least one user device.

In some embodiments, there may be a wireless access point comprising: a means for determining a transmitting power level of the wireless access point; a means for determining a target receiving power level of the wireless access point; a means for transmitting an indication of the transmitting power level and the target receiving power level of the access point to one or more wireless stations; and a means for receiving one or more data transmissions from the one or more wireless stations.

Implementations may include the following features. The transmitting means further comprises: at least one transceiver. The transmitting means may further comprise: at least one antenna coupled to the at least one transceiver. The means for transmitting an indication of the transmitting power level and the target receiving power level may further comprise: means for transmitting the transmitting power level and the target receiving power level in at least one of a trigger frame, beacon, or capabilities advertisement. The at least one trigger frame, beacon, and capabilities advertisement may comprise allocation information for establishing a wireless communication connection between the wireless access point and the one or more wireless stations. Each of the one or more wireless stations may have a same target receiving power level tolerance with respect to the wireless access point. The target receiving power level tolerance may be determined based at least in part on a location of a wireless station of the one or more wireless stations that is located farthest away from the wireless access point. The transmitting means may further comprise: means for transmitting the one or more data transmissions from the one or more wireless stations at respective transmitting power levels equal to the target receiving power level of the access point plus an attenuation level of a wireless communication connection between the wireless access point and the one or more wireless stations. The transmitting means may also comprise: means for determining an attenuation level by subtracting an estimated receiving power level of the access point from the transmitting power level of the access point. The data transmission received from the one or more wireless stations may correspond to the target receiving power level tolerance.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A wireless access point, comprising:
at least one memory storing computer-executable instructions; and
at least one processor configured to access the at least one memory, wherein the at least one processor is configured to execute the computer-executable instructions to:
determine a transmitting power level of the wireless access point;
determine a target receiving power level of the wireless access point;
transmit an indication of the transmitting power level and the target receiving power level of the access point to one or more wireless stations; and
receive one or more data transmissions from the one or more wireless stations.

2. The wireless access point of claim 1, further comprising at least one transceiver configured to transmit and receive wireless signals.

3. The wireless access point of claim 2, further comprising at least one antenna coupled to the at least one transceiver.

4. The wireless access point of claim 1, wherein the indication of the transmitting power level and the target receiving power level of the access point is included in at least one of a trigger frame, a beacon, or a capabilities advertisement.

5. The wireless access point of claim 4, wherein the at least one trigger frame, beacon, or capabilities advertisement comprises allocation information for establishing a wireless communication connection between the wireless access point and the one or more wireless stations.

6. The wireless access point of claim 1, wherein each of the one or more wireless stations has a same target receiving power level tolerance with respect to the wireless access point.

7. The wireless access point of claim 6, wherein the target receiving power level tolerance is determined based at least in part on a location of a wireless station of the one or more wireless stations that is located farthest away from the wireless access point.

8. The wireless access point of claim 1, wherein the one or more data transmissions are transmitted from the one or more wireless stations at respective transmitting power levels equal to the target receiving power level of the access point plus an attenuation level of a wireless communication connection between the wireless access point and the one or more wireless stations.

9. The wireless access point of claim 8, wherein the attenuation level is determined by subtracting an estimated receiving power level of the access point from the transmitting power level of the access point.

10. The wireless access point of claim 1, wherein the data transmission received from the one or more wireless stations corresponds to the target receiving power level tolerance.

11. A wireless station comprising:
at least one memory storing computer-executable instructions; and
at least one processor configured to access the at least one memory, wherein the at least one processor is configured to execute the computer-executable instructions for:
receiving an indication of a transmitting power level and a target receiving power level associated with an access point;
determining a transmitting power level of the wireless station such that the received power level associated with a data transmission to the access point is equivalent to the target receiving power level associated with the access point; and
transmitting one or more data transmissions to the access point using the determined transmitting power level.

12. The wireless station of claim 11, further comprising at least one transceiver configured to transmit and receive wireless signals.

13. The wireless station of claim 12, further comprising at least one antenna coupled to the at least one transceiver.

14. The wireless station of claim 11, wherein the indication of the transmitting power level and the target receiving power level of the access point is included in at least one of a trigger frame, a beacon, or a capabilities advertisement.

15. The wireless station of claim 14, wherein the at least one trigger frame, beacon, or capabilities advertisement comprises allocation information for establishing a wireless communication connection between the wireless access point and the wireless station.

16. A non-transitory computer-readable medium including instructions stored thereon, which when executed by one or more processors of a wireless access point, cause the one or more processors to perform operations of:
determining a transmitting power level of the wireless access point;
determining a target receiving power level of the wireless access point;
transmitting an indication of the transmitting power level and the target receiving power level of the access point to one or more wireless stations; and
receiving one or more data transmissions from the one or more wireless stations.

17. The non-transitory computer-readable medium of claim 16, wherein the indication of the transmitting power level and the target receiving power level of the access point is included in at least one of a trigger frame, a beacon, or a capabilities advertisement.

18. The non-transitory computer-readable medium of claim 17, wherein the at least one trigger frame, beacon, or capabilities advertisement comprises allocation information for establishing a wireless communication connection between the wireless access point and the one or more wireless stations.

19. A method comprising:
determining, by a computing device processor of a wireless access point, a transmitting power level of the wireless access point;
determining, by the computing device processor, a target receiving power level of the wireless access point;
transmitting, by the computing device processor, an indication of the transmitting power level and the target receiving power level of the access point to one or more wireless stations; and
receiving, by the computing device processor, one or more data transmissions from the one or more wireless stations.

20. The method of claim 19, wherein the one or more data transmissions are transmitted from the one or more wireless stations at respective transmitting power levels equal to the target receiving power level of the access point plus an attenuation level of a wireless communication connection between the wireless access point and the one or more wireless stations.

21. The method of claim 20, wherein the attenuation level is determined by subtracting an estimated receiving power level of the access point from the transmitting power level of the access point.

22. The method of claim 19, wherein the data transmission received from the one or more wireless stations corresponds to the target receiving power level tolerance.
